(19) United States
(12) Patent Application Publication
(10) Pub. No.: US 2025/0386817 A1
(43) Pub. Date: Dec. 25, 2025

(54) Bovine Hoof sprayer apparatus, system and method

(71) Applicant: James Holesinsky, Buhl, ID (US)

(72) Inventor: James Holesinsky, Buhl, ID (US)

(21) Appl. No.: 19/246,574

(22) Filed: Jun. 23, 2025

Related U.S. Application Data
(60) Provisional application No. 63/662,874, filed on Jun. 21, 2024.

(51) Int. Cl. A01L 15/00; A01K 13/00

(52) U.S. Cl. CPC A01L 15/00; A01K 13/001

(57) ABSTRACT

A hoof sprayer for bovines and or hoofed animals is disclosed. The sprayer has a spray header that is configured to spray in opposite directions away from the header horizontally. A sensor detects when the bovine approaches the spray header. This actuates the spray nozzles pointing toward the approach of the bovine. As the bovine's hoofs pass over the header, the sensor detects the bovine's hoofs passing and actuates the nozzles on the opposite side of the header to spray the back of the bovine's hoofs. The system can be mounted on a single frame as an apparatus or alternatively the components can be separately configured to accomplish the same purpose.

### PRIORITY/CROSS-REFERENCE TO RELATED APPLICATIONS

This application claims the benefit of U.S. Provisional Application No. 63/662,874, filed Jun. 21, 2024 the disclosure of which is incorporated by reference.

### TECHNICAL FIELD

The presently disclosed technology relates to the application of hoof treatment to bovine hoofs. More particularly, the present invention is an apparatus, system and method for applying hoof treatment, such as chlorine dioxide, to bovine hooves.

### BACKGROUND

Bovine and other hoofed creatures can suffer from a variety of hoof ailments. One such ailment is hoof warts. Hoof warts are caused by a bacteria that is present in environments in which bovine's exist in agriculture. A variety of treatments exist for treating hoof warts. What is needed is an improved mechanism for applying a bovine hoof treatment.

### SUMMARY

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

What is disclosed is a bovine hoof spraying apparatus, system, and method for applying a spray, including chlorine dioxide, to a bovine's hoofs. The apparatus utilizes a frame having installed two sensors. The sensors are connected to an actuator that actuates spraying nozzles on a spray header. The spray header is positioned such that a bovine steps over the spray header. Two of the nozzles are positioned to spray horizontally in a first direction to coat one side of the bovine's hoofs. On the opposite side of the spray header are two or more nozzles positioned and configured to spray in the opposite direction from the first set of nozzles. This second set of nozzles is configured to spray opposite side of the bovine's foot from the second spray nozzles. The first spray nozzles are configured to spray the bovine's front of the hoofs as the bovine approaches the spray header. As the bovine steps over the header, a second sensor detects the bovine and causes the actuation of the second set of spray nozzles. The second set of spray nozzles sprays the back of the bovine's hoofs. The frame is preferably configured for a bovine to pass through the frame. In a preferred embodiment the frame is configured as an arch way. This frame can be utilized in conjunction with a separate chute that guides the bovines through the sprayer.

A system is depicted that utilizes the component of the apparatus but installed independent of a frame. The system utilizes a spray header that has two sets of nozzles positioned and configured to spray in opposing horizontal directions. The first set of nozzles is positioned on a first side of the spray header. The second set of nozzles is positioned on an opposite side of the spray header such that the first and second nozzles spray in opposite directions away from one another. A chute or other frame work that guides the bovine over the spray header is positioned approximate to or connected to the spray header. At least one sensor that is configured to detect when the bovine approaches the header as well as when the bovine hoofs have crossed over in to the spray zone for the second set of nozzles. A method is further disclosed that utilizes the components of the above system to spray a bovine to treat for hoof and or lower leg infections.

A method of spraying bovine hooves with a hoof sprayer is further disclosed.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE FIGURES

FIG. 1 illustrates a perspective view of a hoof spraying apparatus installed within a bovine chute.

FIG. 2 illustrates a front view of the bovine spraying apparatus installed in conjunction with a chute for directing bovines into the spraying apparatusbov.

FIG. 3 illustrates a sideview of the bovine hoof spraying apparatus installed within a chute.

FIG. 4 illustrates a prospective view of a bovine entering the hoof spraying apparatus.

FIG. 5 illustrates a sideview of a bovine entering the hoof spraying apparatus of FIG. 1-5.

FIG. 6 illustrates a perspective view of a bovine approaching the spraying header of the hoof spraying apparatus.

FIG. 7 illustrates a perspective view of the bovine positioned in the hoof spraying apparatus with the hoof spraying apparatus spraying the hoofs.

FIG. 8 illustrates a perspective view of the bovine passing through the apparatus having rear spray nozzles actuated.

FIG. 9 illustrates the hoofs of the bovine with applicator applied.

FIG. 10 illustrates a flow diagram of a system for spraying bovine hoofs.

FIG. 11 illustrates a circuit diagram illustrating the electrical flow of the spraying apparatus.

### DETAILED DESCRIPTION

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

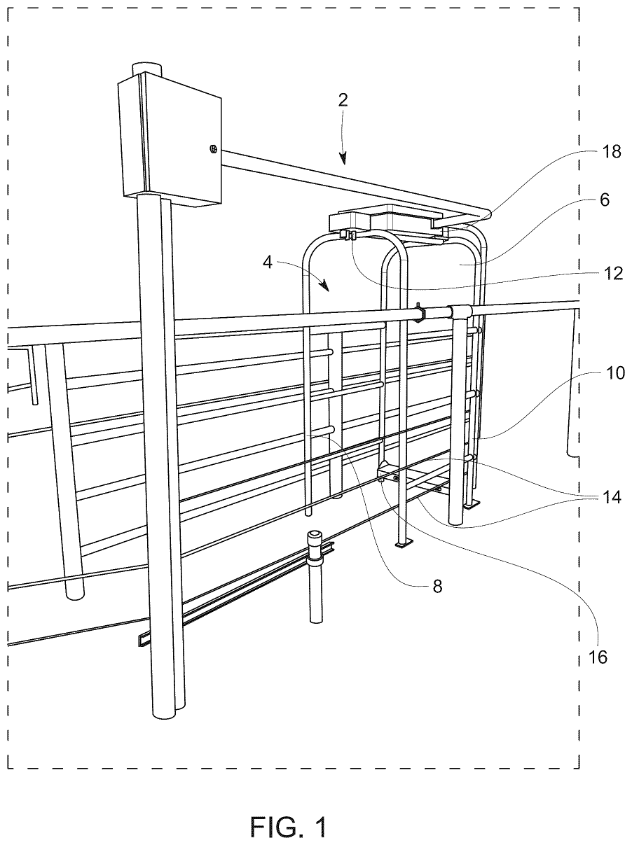

FIG. 1 illustrates the spay apparatus 2 having an entrance opening 4 and an exit opening 6 defined by an entrance frame 8 and exit frame 10. A front actuator 12, preferably a laser eye, is positioned to detect the entry of a bovine into the apparatus. The actuator, being a sensor connected to a processor, actuates a first pair of spray nozzles 14 positioned on a first side of a spray header 16. The spray header extends perpendicular in the apparatus to the direction of travel through the apparatus by the bovine. The first pair of spray nozzles are configured to spray the front of a bovine's hooves as the bovine approaches the apparatus and travels through the apparatus. FIG. 1 also depicts an integrated system that is formed as a single apparatus.

A second sensor or actuator 18 is positioned proximate to the exit opening. The second actuator detects when a bovine has traveled over the spray header. A second pair (an alternate number of spray nozzles can be utilized on either side) of nozzles sprays the back of the bovine's hooves as the bovine exits the apparatus. The nozzles spray a mixture of compressed air and chlorine dioxide. The use of chlorine dioxide with compressed air causes increased coverage in that the air currents cause circulation of air and mixture effectively coating the hooves.

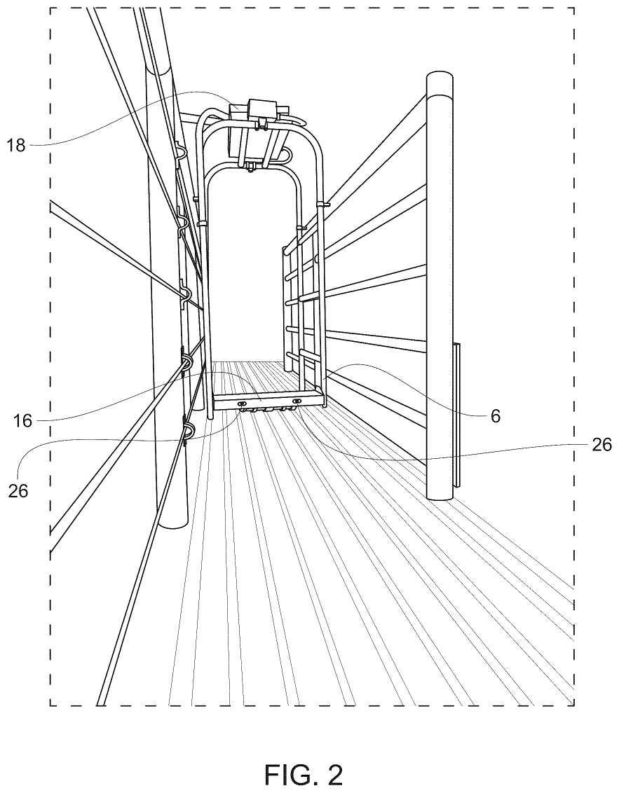

FIG. 2 illustrates the apparatus looking through the exit opening. The spray header 16 contains the second set of spray nozzles 26. The apparatus is positioned in a series of rails defining a chute that directs the bovine to travel through the apparatus.

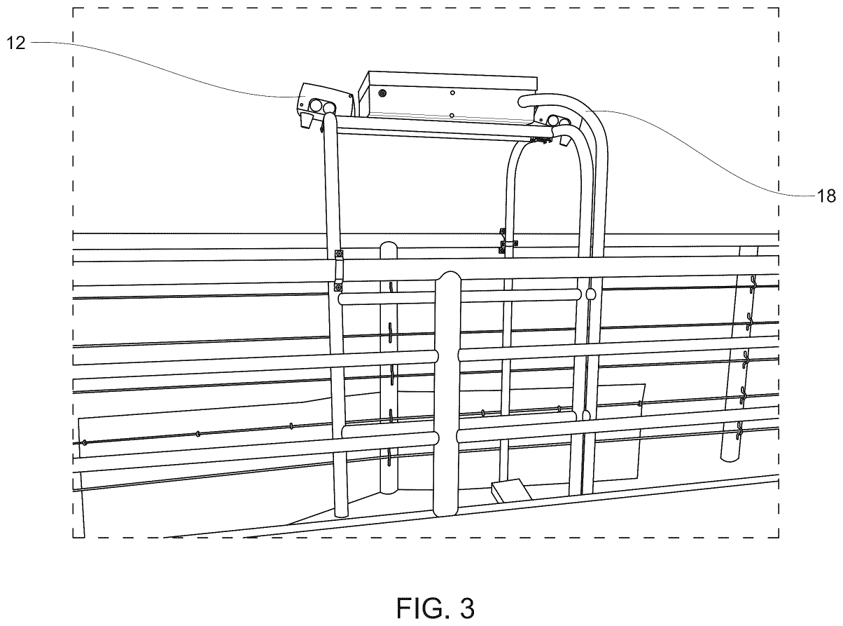

FIG. 3 illustrates a side view of the apparatus showing the orientation of the first sensor 18 and the second sensor having lasers pointing downward. The downward pointing laser sensor detects when a bovine travels below the sensor.

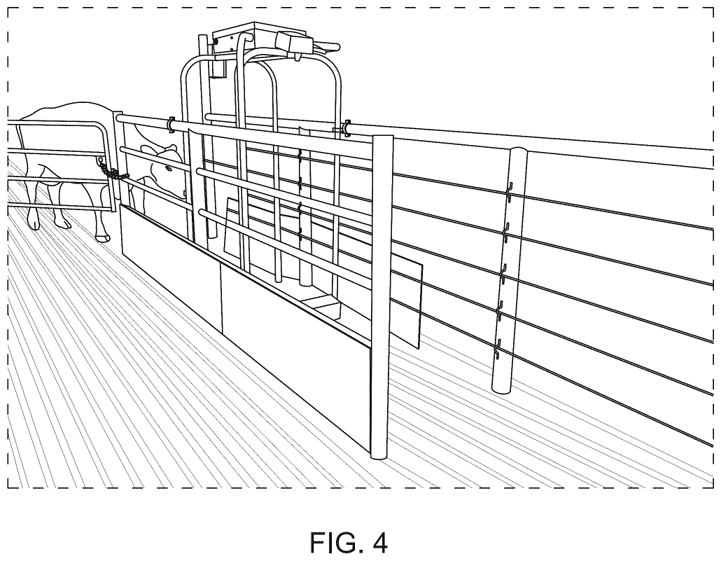

FIG. 4 illustrates a bovine traveling down a chute toward the spray apparatus.

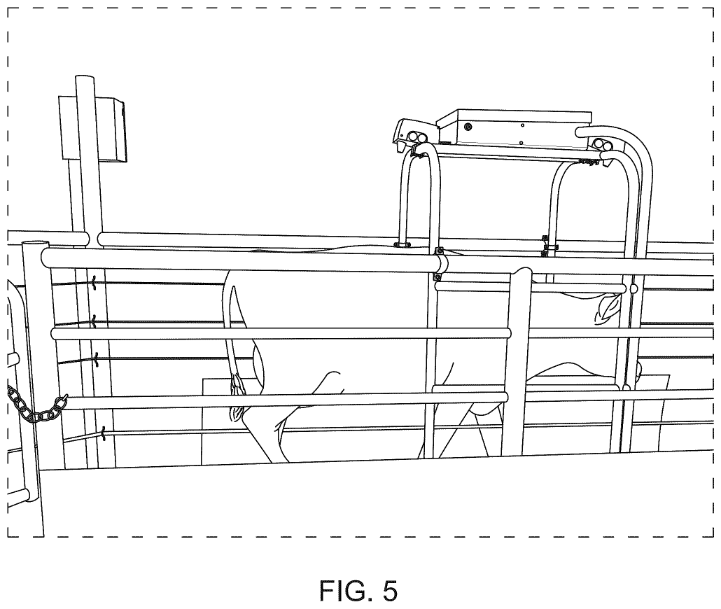

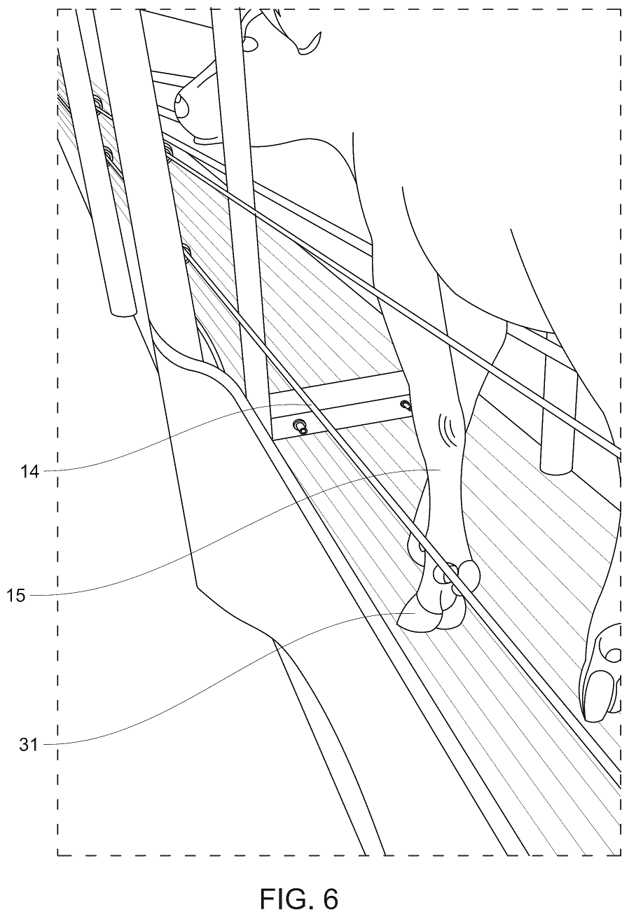

FIG. 5 illustrates a bovine traveling through the hoof spraying apparatus. As the bovine is detected by the first sensor, the processor actuates solenoids causing compressed air and chlorine dioxide to spray from the first nozzles. This coats the front of the bovine hooves. The sprayer preferable sprays in bursts of air. As the bovine travels toward the exit, the bovine steps over the spray header and actuates the front sensor, causing the spray nozzles on the exit side of the spray header to spray the back of the bovine hooves.

FIG. 6 illustrates the bovine entering the apparatus with the rear facing (or first) spray nozzles 14 spraying 15 the front of the bovine's front hooves 31.

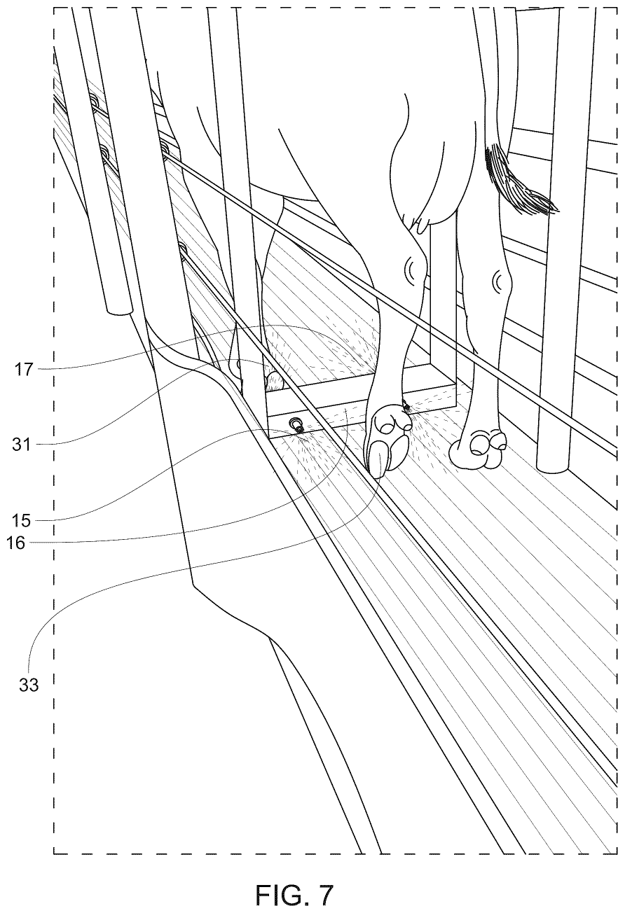

FIG. 7 illustrates the bovine having stepped over the spray header 16 with the exit facing nozzles (hidden by header) spraying 17 the back of the bovine's front hooves. The rear facing spray nozzles are spraying the front of the bovine's rear hooves 33.

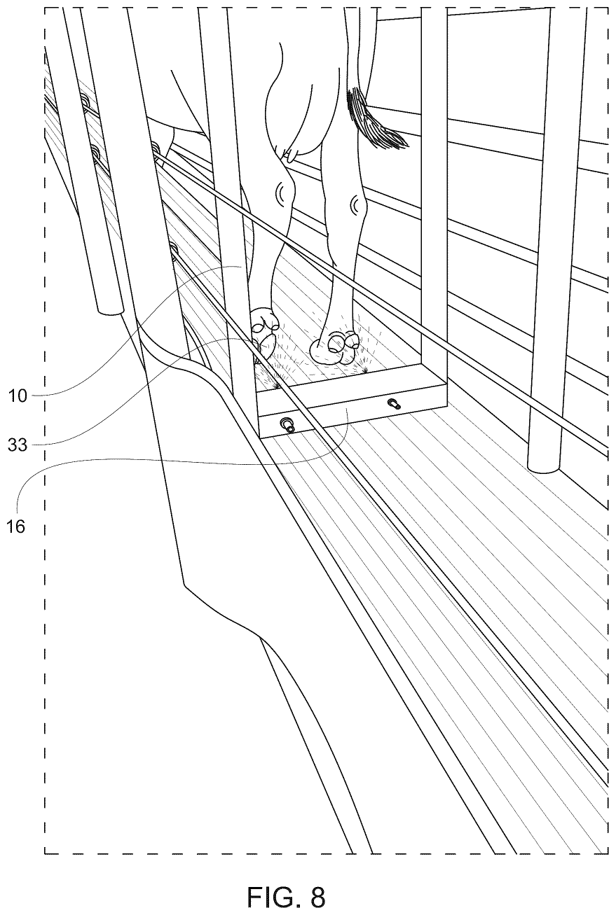

FIG. 8 illustrates the bovines rear hooves having stepped over the spray header 16. The forward facing nozzles are spraying 17 the back of the bovine's rear hooves.

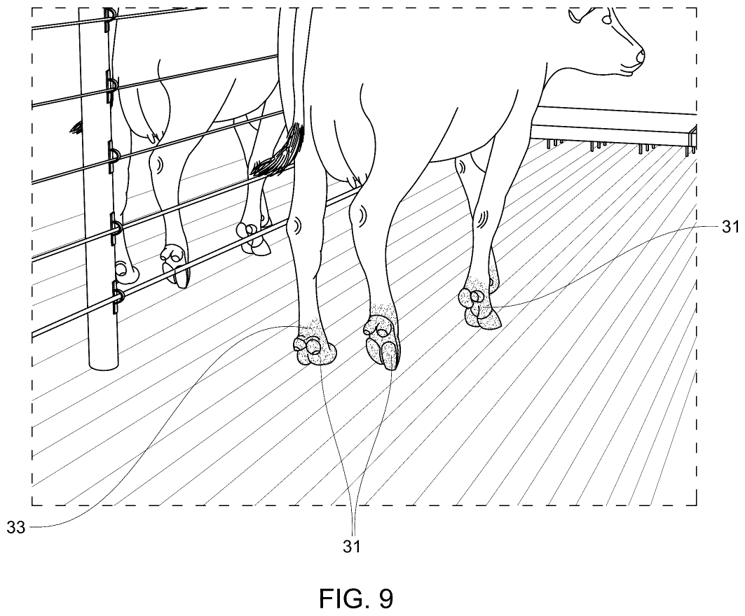

FIG. 9 illustrates a bovine having exited the apparatus, showing the coating of the bovine's hooves in blue from the chlorine dioxide spray incorporating a blue dye, shown in shading.

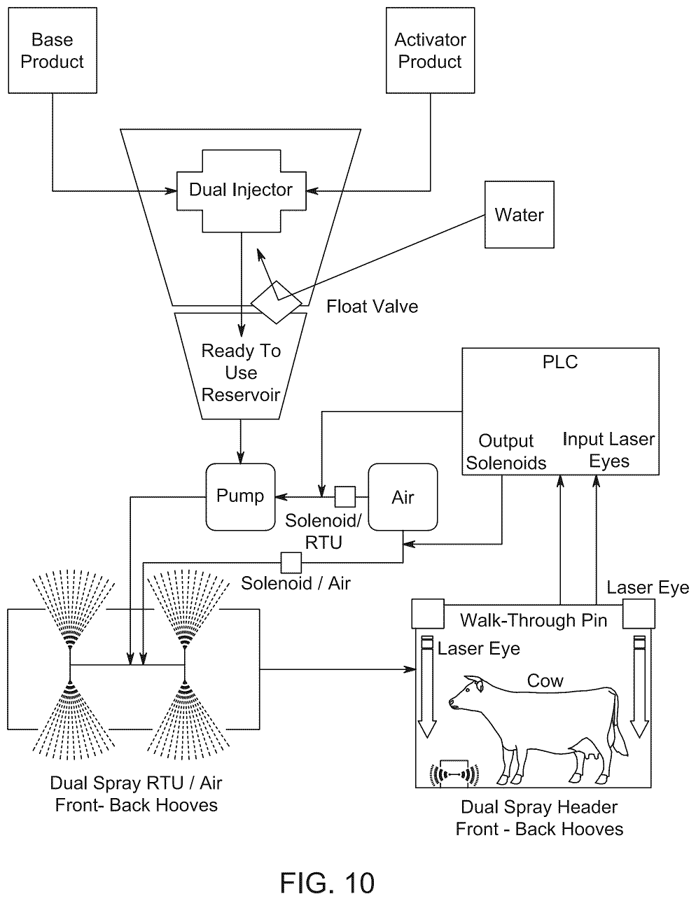

FIG. 10 illustrates a flow chart showing the processing of the spraying apparatus. In the embodiment of FIG. 10 the chlorine dioxide is generated by the system mixing a base product with an activator and water, as is commonly know for the generation of chlorine dioxide. The system generates an amount of chlorine dioxide that can be used within a time frame to prevent degradation of the chlorine dioxide. When the amount of chlorine dioxide in the reservoir is low, a sensor provides a signal to a processor that causes the system to generate more chlorine dioxide liquid. In the depicted embodiment the sensor is a float sensor. The base product and activator are mixed by an injector.

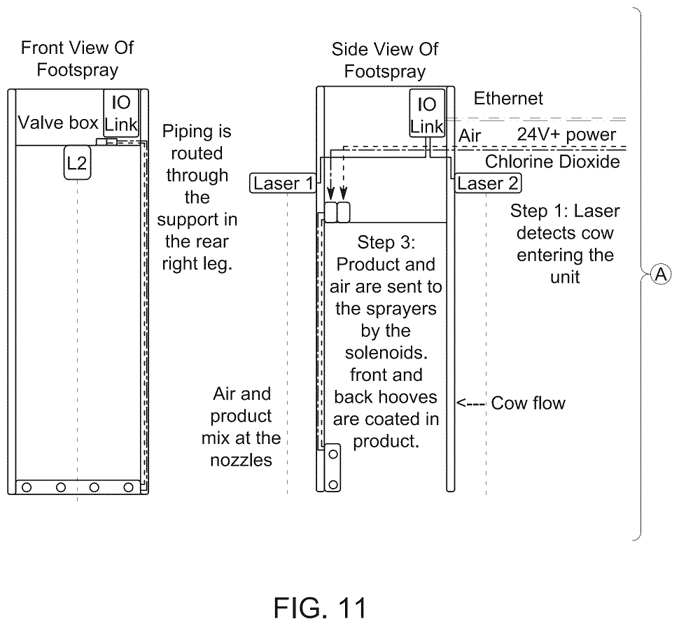

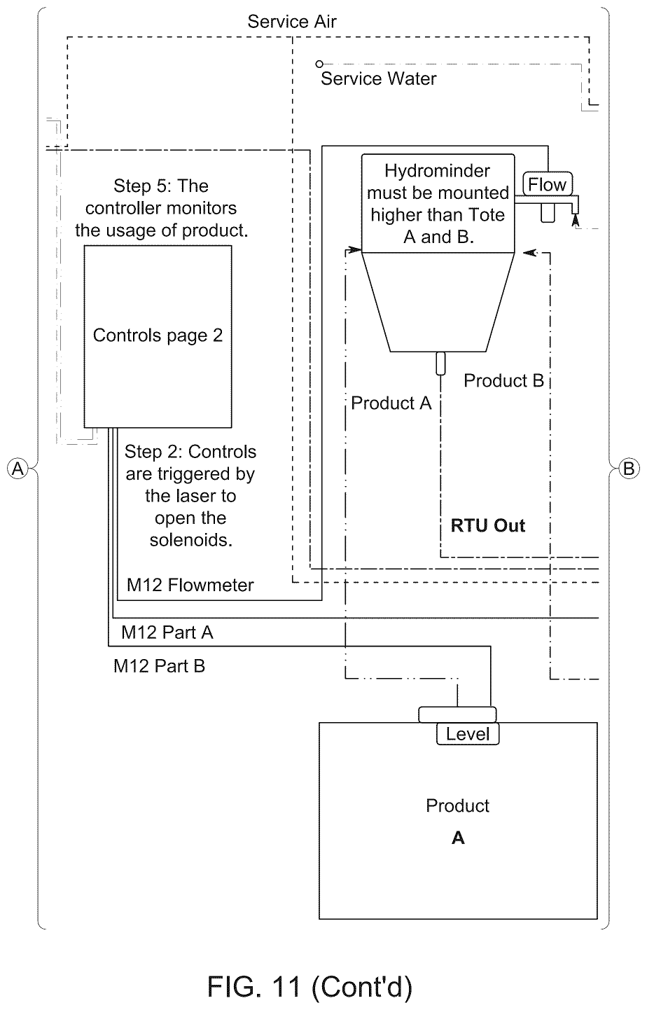

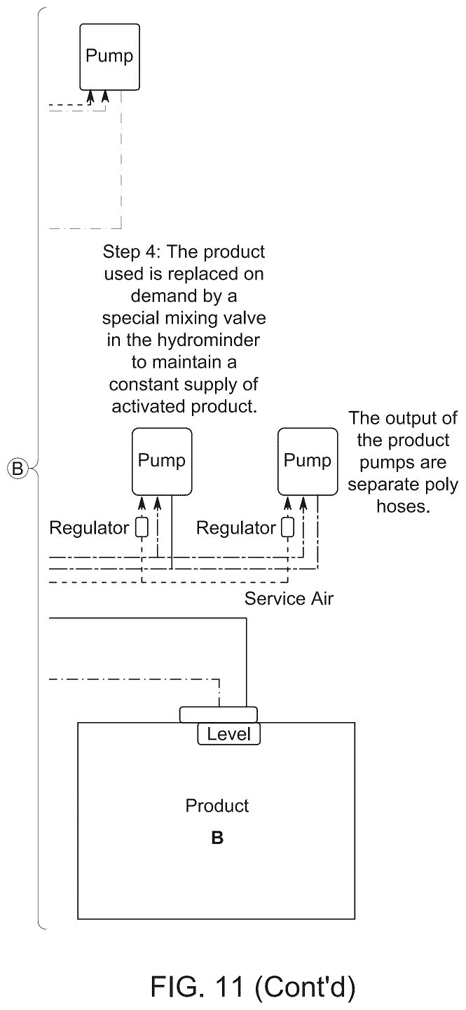

FIG. 11 illustrates a circuit diagram showing the fluid and electrical flow of the spraying apparatus.

The figures above depict a preferred embodiment of the apparatus, system and method.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. An apparatus for spraying a hoof of a bovine, said apparatus comprising:
a frame configured for passage through an opening of the frame by a bovine;
a spray header extending across said frame and configured and positioned for the bovine to step over said spray header when the bovine is passing through the frame;
wherein said spray header comprising at least one first side spray nozzle positioned in a spray header first side and configured to spray horizontally away from the spray header first side,
wherein said spray header comprising at least one second side spray nozzle positioned in a spray header second side and configured to spray horizontally away from said spray header second side, wherein said spray header first side and said spray header second side being positioned opposite one another;
at least one sensor configured to detect when a hoof of said bovine is in front of said first side spray nozzle and to detect when a bovine is in front of said second side spray nozzle;
a processor in communication with said sensor to receive a notification from said sensor that a bovine is in front of said first side spray nozzle and/or said second side spray nozzle; and
at least one actuator configured to separately deliver fluid to said first side spray nozzle and said second side spay nozzle in response to a signal from said processor.

2. The apparatus of claim 1 wherein said liquid comprises chlorine dioxide.

3. The apparatus of claim 1 wherein said sensor comprises a laser eye sensor.

4. The apparatus of claim 1 wherein said at least one sensor comprises a first sensor and a second sensor, wherein said first sensor is configured to detect when a bovine is positioned in front of said first side spray nozzle, wherein said second sensor is configured to detect when said bovine is in front of said second side spray nozzle.

5. The apparatus of claim 4 wherein said first sensor is positioned proximate to an entry opening of said frame, wherein said second sensor is positioned proximate to an exit opening of said frame.

6. The apparatus of claim 1 wherein said first side spray nozzle and said second side spray nozzle are configured to spray in a horizontal fan spray pattern.

7. The apparatus of claim 1 wherein said apparatus comprises a reservoir for storing activated chlorine dioxide, wherein said reservoir is in fluid connection with said spray nozzles.

8. The apparatus of claim 1 further comprising a pump to pump activated chlorine dioxide to said spray nozzles.

9. A bovine hoof spray system comprising:
a spray header extending across a bovine chute and configured and positioned for the bovine to step over said spray header when the bovine is passing through the frame;
wherein said spray header comprising at least one first side spray nozzle positioned in a spray header first side and configured to spray horizontally away from the spray header first side, wherein said spray header comprising at least one second side spray nozzle positioned in a spray header second side and configured to spray horizontally away from said spray header second side, wherein said spray header first side and said spray header second side being positioned opposite one another;
at least one bovine sensor configured to detect when a hoof of said bovine is in front of said first side spray nozzle and to detect when a bovine is in front of said second side spray nozzle;
a processor in communication with said sensor to receive a notification from said sensor that a bovine is in front of said first side spray nozzle and/or said second side spray nozzle;
at least one actuator configured to separately deliver fluid to said first side spray nozzle and said second side spay nozzle in response to a signal from said processor;
a chlorine dioxide reservoir for storing a liquid comprising activated chlorine dioxide in fluid communication with said first side spray nozzle and said second side spray nozzle; and
a pump configured to pump said liquid comprising activated chlorine dioxide to said first side sprayers and said second side sprayers.

10. The system of claim 9 further comprising a base product reservoir and an activator product reservoir in fluid communication with said chlorine dioxide reservoir, wherein said chlorine dioxide reservoir comprises a level sensor configured to detect the level of chlorine dioxide liquid in said reservoir, wherein said system comprises an injector configured to mix said base product with said activator and water to generate said chlorine dioxide liquid when said sensor detects a low level of chlorine dioxide liquid in said chlorine dioxide reservoir.

11. The system of claim 9 wherein said at least one bovine sensor comprises a first sensor and a second sensor, wherein said first sensor is configured to detect a bovine in front of said first spray nozzle, wherein said second sensor is configured to detect a bovine in front of said second spray nozzle.

12. A method of treating the hooves of a bovine, said method comprising:
a step of providing a spray system for spraying bovine hooves, said spray system comprising:
a spray header extending across a bovine chute and configured and positioned for the bovine to step over said spray header when the bovine is passing through the frame,
wherein said spray header comprising at least one first side spray nozzle positioned in a spray header first side and configured to spray horizontally away from the spray header first side, wherein said spray header comprising at least one second side spray nozzle positioned in a spray header second side and configured to spray horizontally away from said spray header second side, wherein said spray header first side and said spray header second side being positioned opposite one another;
at least one bovine sensor configured to detect when a hoof of said bovine is in front of said first side spray nozzle and to detect when a bovine is in front of said second side spray nozzle;
a processor in communication with said sensor to receive a notification from said sensor that a bovine is in front of said first side spray nozzle and/or said second side spray nozzle;
at least one actuator configured to separately deliver fluid to said first side spray nozzle and said second side spay nozzle in response to a signal from said processor;
a chlorine dioxide reservoir for storing a liquid comprising activated chlorine dioxide in fluid communication with said first side spray nozzle and said second side spray nozzle; and
a pump configured to pump said liquid comprising activated chlorine dioxide to said first side sprayers and said second side sprayers;
the step of directing a bovine through said chute and across said spray header to cause said system to spray the hooves of said bovine.

13. The method of claim 12 further comprising a step of mixing a base product with an activator to generate said chlorine dioxide liquid stored in said chlorine dioxide reservoir.

14. The method of claim 13 wherein said step of mixing said base product with an activator comprises mixing water with said base product and said activator.

15. The method of claim 12 wherein said at least one bovine sensor comprises a first sensor and a second sensor, wherein said first sensor is configured to detect when a bovine is positioned in front of said first side spray nozzle, wherein said second sensor is configured to detect when said bovine is in front of said second side spray nozzle.

16. The method of claim 12 wherein said at least one sensor is a laser eye sensor.
